(19) United States
(12) Patent Application Publication
(10) Pub. No.: US 2009/0129346 A1
(43) Pub. Date: May 21, 2009

(54) Method and Apparatus for Monitoring TCP Sessions in a Mobile Data Network and Developing Corresponding Performance Metrics

(76) Inventor: Tengywe E. Hong, Naperville, IL (US)

Correspondence Address: FITCH EVEN TABIN AND FLANNERY, 120 SOUTH LASALLE STREET, SUITE 1600, CHICAGO, IL, 60603-3406, US

(21) Appl. No.: 11/935,154

(22) Filed: Nov. 5, 2007

Related U.S. Application Data
(60) Provisional application No. 60/856,980, filed on Nov. 6, 2006.

(51) Int. Cl. H04W 4/00

(52) U.S. Cl. 370/338

(57) ABSTRACT

These teachings provide for receiving (101) TCP packets as comprise a part of a packet data flow that itself comprises, at least in part, a mobile data flow. These TCP packets are then used (102) to detect when the mobile data flow as comprises a mobile data session has been dropped by a corresponding mobile network.

### CROSS-REFERENCE TO RELATED APPLICATION

This application claims the benefit of U.S. Provisional application Ser. No. 60/856,980, filed Nov. 6, 2006, which is incorporated by reference in its entirety herein.

### TECHNICAL FIELD

This invention relates generally to data sessions and more particularly to mobile data sessions in a mobile network.

### BACKGROUND

Communication networks of various kinds are known in the art. This includes mobile networks that serve to provide one-way and two-way communications for mobile end user platforms such as cellular telephones, laptops (and other computers having a small personally portable form factor), personal digital assistants, and so forth. Such networks often support a variety of communication activities using a wide variety of supporting data protocols including, but certainly not limited to, Transfer Control Protocol (TCP).

Unfortunately, such networks are not perfect. As a result, and for any of a myriad of reasons, a given communication session can be dropped. Detecting such drops can comprise an important activity for a network administrator. Such information can be used, for example, to influence diagnostic conclusions, architectural modifications and/or additions, resource reallocations, and so forth. Accordingly, and as one example in this regard, active data session drop detectors exist that are able to detect a dropped data session. Such detectors typically comprise specialized network probes. For example, probes exist to interact with 3GPP mobile network interfaces and capture data session control messages from various 3GPP network elements (such as NodeB's, RNC's, SGSN's, GGSN's, and so forth).

Unfortunately, such existing approaches present numerous implementation challenges as networks grow larger and ever more complex. With 3GPP active data sessions again as an example, existing probes are interface specific. This, in turn, requires deployment of a variety of probes (such as Gn/Gp interface probes, IuPS probes, Iub probes, and so forth) in order to be assured of developing the desired information regarding dropped active data sessions.

As a related problem, 3GPP mobile data network operators must decode various protocols (such as, but not limited to, IP, GTP, OCx, ATM, RANAP, RLC, and so forth) for these above-mentioned varied mobile network interfaces. This, in turn, typically requires a variety of vastly different software decoders to accommodate these different interfaces.

These and various other problems greatly increase engineering complexity, cost, and operational requirements when seeking to employ prior approaches to detect dropped active data sessions. These problems only grow worse as networks themselves continue to grow larger and more complex.

### BRIEF DESCRIPTION OF THE DRAWINGS

The above needs are at least partially met through provision of the method and apparatus regarding using TCP packets to detect when a mobile data flow has been dropped by a mobile network described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a block diagram as configured in accordance with various embodiments of the invention;

FIG. 4 comprises a block diagram as configured in accordance with various embodiments of the invention; and

FIG. 5 comprises a flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, these teachings provide for receiving TCP packets as comprise a part of a packet data flow that itself comprises, at least in part, a mobile data flow. These TCP packets are then used to detect when the mobile data flow as comprises a mobile data session has been dropped by a corresponding mobile network.

This can comprise, for example, tracking TCP sequence numbers as correspond to the packet data flow and using such tracking information to facilitate the described functionality. This can also comprise, for example, detecting TCP downlink retransmission packets and also using that information to facilitate the described functionality.

These teachings will also accommodate, if desired, automatically transmitting the detection of a dropped active data session and/or identifying a service delivery component that is at least partially responsible for dropping the active data session (for example, by obtaining identifying information for the service delivery component from a packet data protocol activation message on, for example, a Gn interface).

So configured and arranged, those skilled in the art will recognize and appreciate that a single type of probe can be employed to detect dropped active data sessions at aggregation points in a given network, thereby obviating the previous need to deploy numerous and various types of probes at diverse mobile network interfaces. It will similarly be appreciated that these teachings permit avoiding the need to decode a wide variety of protocols as are associated with differing mobile network interfaces. These teachings are highly scalable and will accommodate very large network configurations. It will further be appreciated that these teachings can reduce a field deployment activity from many months to merely a few days.

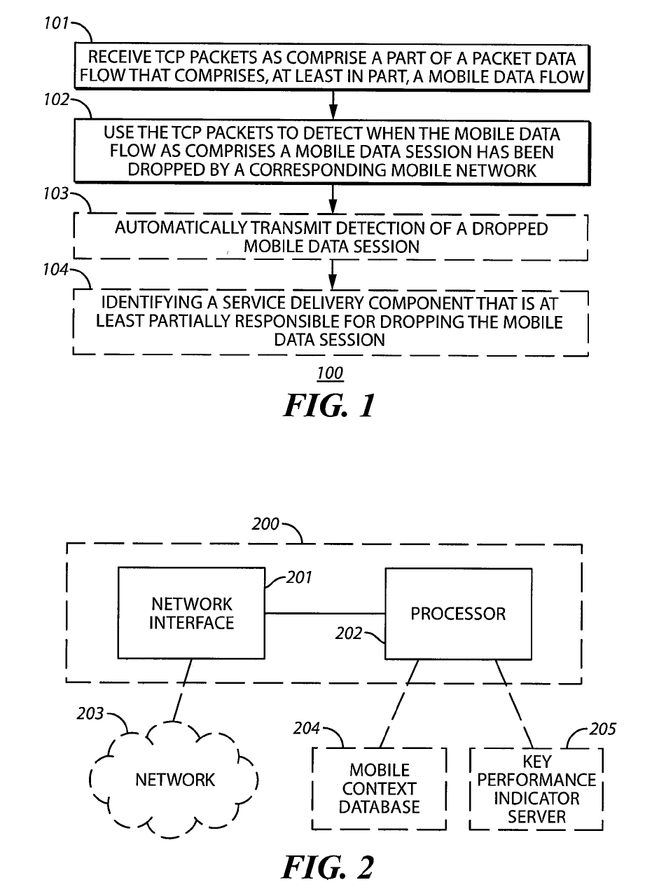

These and other benefits may become clearer upon making a thorough review and study of the following detailed description. Referring now to the drawings, and in particular to FIG. 1, an illustrative process that is compatible with many of these teachings will now be presented.

This process 100 generally provides for receiving 101 TCP packets as comprise a part of a packet data flow that itself comprises, at least in part, a mobile data flow. By one approach, and as will be shown below in more detail, these TCP packets can comprise mirrored mobile data packets.

This process 100 then provides for using 102 the TCP packets to detect when the mobile data flow as comprises a mobile data session has been dropped by a corresponding mobile network. This can comprise, in a typical application setting, decoding the data flow up to an Internet Protocol layer to facilitate this detection functionality. This can also comprise discarding packets that do not comprise TCP packets (particularly as the TCP packets being assessed as per these teachings may comprise, by one approach, mirrored mobile data packets and hence their discard will not interfere with the ultimate delivery of such packets to their intended target destination).

This detection activity can comprise, if desired, tracking TCP sequence numbers as correspond to the packet data flow. By one approach, when a present downlink TCP packet sequence number is less than or equal to a last sequence number for a given packet, these teachings can provide for setting a TCP retransmission ending indicator. Conversely, when a present uplink TCP is detected, that TCP retransmission ending indicator can be cleared.

Also by one approach, if desired, this detection step can comprise determining whether a mobile network-sourced session ending control message has been sent to indicate that a mobile portion of the mobile data flow has ended. When true, this step can then further comprise determining whether the aforementioned TCP retransmission ending indicator has been set. Further, and again if desired, this detection step can comprise (when a current TCP packet comprises a positive TCP retransmission ending indicator under such circumstances as those just described), determining that the mobile data session has indeed been dropped.

As one example in this regard, this can comprise determining whether a present TCP packet having a sequence number that is less than or equal to a last sequence number also comprises a TCP downlink retransmission packet when a session ending control message exists to signify that a mobile portion of the mobile data flow has ended. By another approach, one need not rely upon (or wait for) such a network-based session ending control message. Instead, temporal TCP behavior can be taken into account. As an illustrative and non-limiting example in this regard, a TCP-based drop detection can be asserted when the aforementioned TCP drop ending indicator is set and there is no TCP traffic for more than some predetermined period of time. This predetermined time, for many applications, can comprise but a few minutes such as two minutes.

A more detailed illustrative example of an instantiation in these regards will be provided below for the interested reader.

If desired, this process 100 will further accommodate automatically transmitting 103 the detection of a dropped active data session. This can comprise, for example, transmitting such information to a system/network data repository where such information is temporarily or permanently archived. This might also comprise, for example, transmitting such information to a key performance indicator server where network performance is measured, quantified, or the like.

This process 100 will also optionally accommodate, if desired, identifying 104 a service delivery component that is at least partially responsible for dropping the active data session. This can comprise, for example, identifying a particular wireless base station, mobile handset, wireless base station controller, SGSN, or other network node that constitutes the point at which the active data session was dropped. By way of example and not by way of limitation, this step might comprise obtaining identifying information for the service delivery component from a packet data protocol (PDP) activation message on, for example, a Gn interface.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

As illustrated, an active data session drop detector 200 can be generally comprised of a network interface 201 and a processor 202 that operably couples to the network interface 201. The network interface 201 can be configured and arranged to receive TCP packets as comprise a part of the aforementioned packet data flow as comprises, at least in part, a mobile data flow. Many network interface examples are known in the art and others are likely to be developed in the future. These teachings are generally suitable for use with any such examples. For the purposes of illustration, however, it will be assumed that this network interface 201 comprises an Ethernet interface. (As used herein, “Ethernet” will be understood to refer to wiring and signaling standards as are proscribed in the IEEE 802.3 standard.)

The processor 202, in turn, can comprise a hard-wired dedicated purpose platform or a partially or wholly programmable platform. Such architectural options are well known in the art are require no further elaboration here. For the sake of illustration it will be presumed that the processor 202 comprises a microcontroller or a microprocessor of choice.

The processor 202 is configured and arranged (via, for example, corresponding programming as will be well understood by those skilled in the art) to carry out some or all of the steps, actions, and/or functionality as are described herein as may be desired. This can comprise, for example, using TCP packets as are received via the network interface 201 to monitor an active data session to thereby detect when the mobile data flow has been dropped by a corresponding mobile network. By one approach, this processor 202 is configured and arranged to carry out and/or otherwise facilitate all of the steps described herein.

To effect these purposes, the network interface 201 will typically couple to one or more networks 203 including, but not limited to, the aforementioned mobile network. The processor 202, in turn, can operably couple to a mobile context database 204, a key performance indicator server 205, and so forth as desired. The value of such connections has been alluded to above and will be described in more detail below.

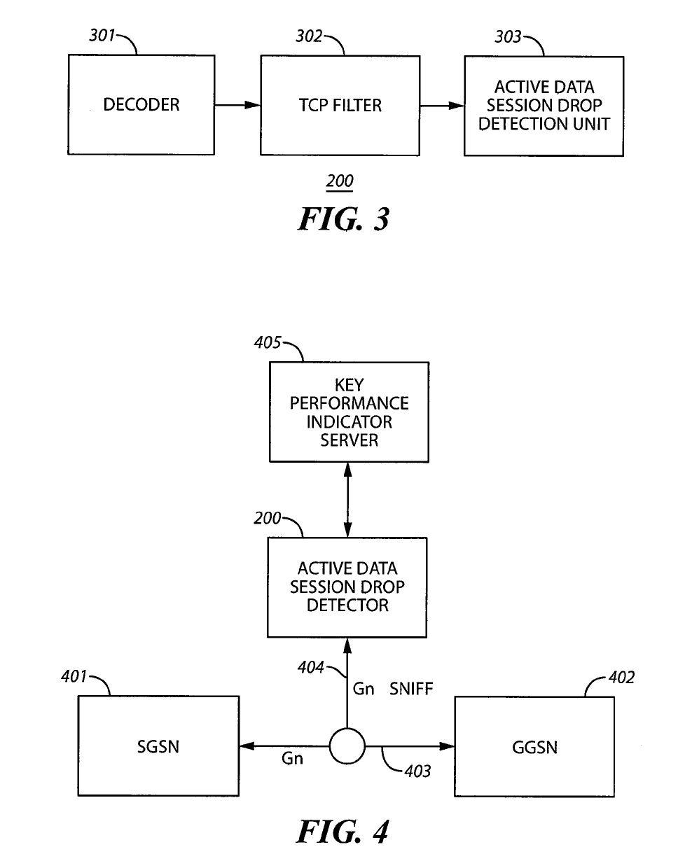

Referring now to FIG. 3, an illustrative logical representation of one approach to realizing an active data session drop detector 200 can comprise a decoder 301 that receives the aforementioned mirrored data packets and which decodes the encapsulation protocols for the TCP packets. The decoded results are then provided to a TCP filter 302.

The TCP filter 302, in turn, determines whether the forwarded packets comprise TCP packets. Packets that fail this test are discarded and TCP packets are forwarded to an active data session drop detection unit 303. The latter serves to assess when an active data session drop occurs and to create, for example, a corresponding key performance indicator account regarding that drop. The processed TCP packets can then be discarded as well.

Those skilled in the art will recognize and understand that such an apparatus 200 may be comprised of a plurality of physically distinct elements as is suggested by the illustrations shown in FIGS. 2 and 3. It is also possible, however, to view these illustrations as comprising a logical view, in which case one or more of these elements can be enabled and realized via a shared platform. It will also be understood that such a shared platform may comprise a wholly or at least partially programmable platform as are known in the art.

As noted, these teachings are relevant to a variety of network architectures. FIG. 4 provides one illustrative example in this regard amongst many that are possible. Those skilled in the art will recognize that this example is intended for the purposes of illustration and not by way of limitation.

This illustrative example depicts an active data session drop detector 200 deployed as a probe in a 3GPP-based core network. The probe is positioned to process at least Gn traffic 403 as flows between a Serving GPRS Support Node (SGSN) 401 and a Gateway GPRS Support Node (GGSN) 402 as are known in the art. In this embodiment, the probe is receiving mirrored Gn traffic 404. The probe processes this mirrored Gn traffic as described herein and reports detected dropped active data sessions to a key performance indicator server 405.

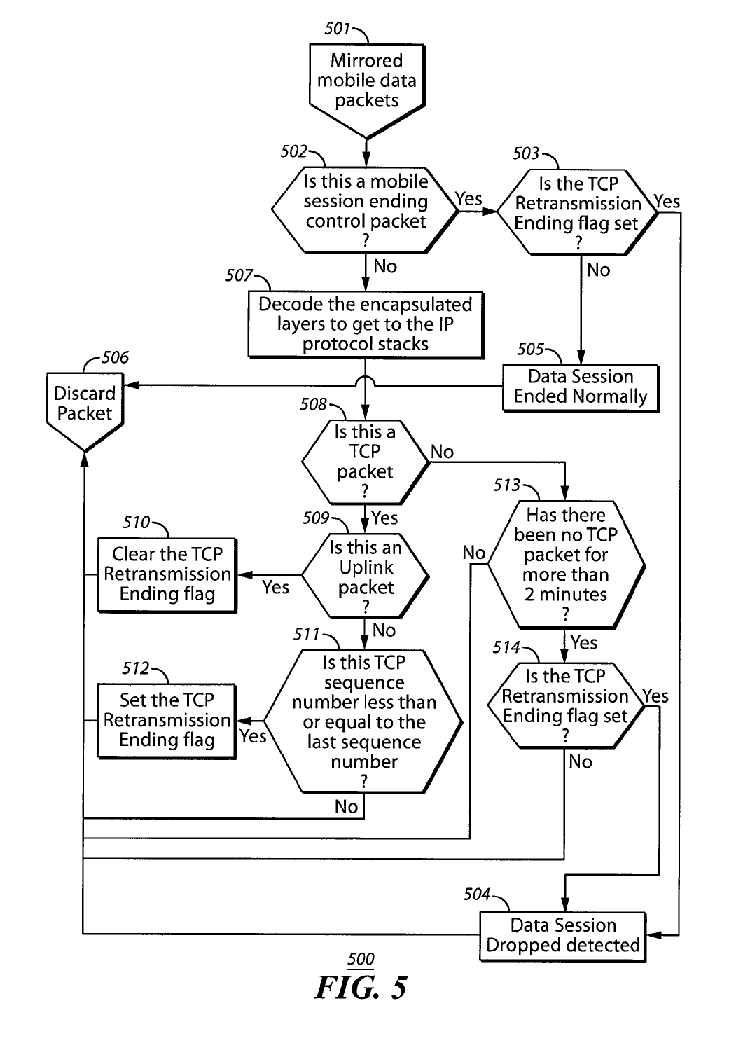

Referring now to FIG. 5, an illustrative exemplary corresponding process 500 will be described. Those skilled in the art will recognize that other possibilities exist in this regard as well with yet others likely to be developed going forward.

This process 500 begins with the step 501 of receiving the aforementioned mirrored Internet Protocol (IP)-based mobile data packets via the aforementioned Ethernet port. This step 501 can comprise saving these packets in one or more data buffers.

In a next step 502, this process 500 then determines, at step 502, whether each of the buffered mobile-protocol-encapsulated mobile data packets indicate that the mobile session has ended. In particular, this can comprise, for example, checking to determine if the corresponding network has sent a session ending control packet to signify that the end user's data session is ended. When true, this process 500 then determines, at step 503, whether a TCP retransmission ending flag (as described below in more detail) has been set. If so, this process 500 then detects, at step 504, that the data session has been dropped. Otherwise, this process 500 concludes, at step 505, that the data session has ended normally following which the packet is discarded at step 506.

When step 502 determines that the packet does not comprise a mobile session ending control packet, this process 500 then provides, at step 507, for decoding the encapsulated layers of the packet up to the Internet Protocol layers in order to thereby provide access to the IP stacks contained therein. This process 500 then determines at step 508 whether the data packet comprises a TCP packet. When true, this process 500 determines at step 509 whether each data packet comprises an uplink packet (i.e., a packet that is moving from a mobile platform/application to an upstream server/application).

When true, this process 500 can next execute a clearing step 510 that clears the aforementioned TCP retransmission ending flag. An uplink packet, of course, signifies that data is flowing from the mobile platform upstream to the application server. In the present context, this rules out a possibility of a session drop based on the TCP characteristics as each downlink packet requires active acknowledgement in the uplink direction. This result can be written, for example, to the aforementioned mobile context database 204 to thereby make this information available to the execution of other steps set forth herein.

Otherwise, when the data packet does not comprise an uplink packet, this process 500 determines at step 511 whether the current TCP sequence number is less than or equal to the last TCP sequence number in the same connection. When true, the present TCP packet is recognized as a retransmitted packet and the TCP retransmission ending flag is set at step 512 to signify that the last TCP packet was a TCP retransmission. If desired, this, too, can be written to the aforementioned mobile context database 204. Those skilled in the art will recognize that step 511 can be facilitated in a variety of ways. By one approach, the sequence numbers of at least the TCP packets as comprise a given session are tracked in order to provide a basis for making the described determination regarding whether a current TCP sequence number is less than or equal to a last sequence number. These tracking results might be stored, for example, in the aforementioned mobile context database 204.

At the conclusion of step 511, and following the clearing or setting of the TCP retransmission ending flag in steps 510 and 512, respectively, this process provides for discarding the packet at the aforementioned step 506.

When the previously described step 508 proves false (meaning that the data packet does not comprise a TCP packet), the process 500 then determines at step 513 whether any TCP packets for this particular session within some predetermined period of time. In this illustrative example, this predetermined period of time is two minutes. Those skilled in the art will recognize that other times of shorter or longer duration may be selected for use depending upon the needs and/or opportunities presented by a given specific application setting. When a TCP packet for this session has been received within this predetermined period of time, this process 500 then simply provides for discarding the packet at step 506.

When there has been no TCP packet received for more than the predetermined period of time, however, this process 500 then provides for determining, at step 514, whether the TCP retransmission ending flag is set. If not, the packet is discarded at step 506. When the TCP retransmission ending flag has been set, however, this process 500 then provides, at step 504, for again detecting that the data session has been dropped rather than terminated normally.

So configured, those skilled in the art will recognize and appreciate that the described teachings, while being highly effective in use, are nevertheless relatively simple and inexpensive to deploy and implement. A single probe as described, properly coupled at a suitable point of aggregated traffic in a monitored network, can readily and successfully detect dropped active data sessions in a mobile data session context in a manner that avoids numerous issues, complications, and obstacles as are ordinarily associated with traditional approaches in this regard.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
receiving Transfer Control Protocol (TCP) packets as comprise a part of a packet data flow that comprises, at least in part, a mobile data flow;
using the TCP packets to detect when the mobile data flow as comprises a mobile data session has been dropped by a corresponding mobile network.

2. The method of claim 1 wherein receiving TCP packets comprises receiving mirrored mobile data packets.

3. The method of claim 1 wherein using the TCP packets to detect when the mobile data flow has been dropped by a corresponding mobile network comprises:
tracking TCP sequence numbers as correspond to the packet data flow; and
detecting TCP downlink retransmission packets.

4. The method of claim 1 wherein using the TCP packets to detect when the mobile data flow has been dropped by a corresponding mobile network comprises decoding the data flow up to an Internet Protocol layer.

5. The method of claim 1 wherein using the TCP packets to detect when the mobile data flow has been dropped by a corresponding mobile network comprises determining whether a present TCP packet which has a sequence number that is less than or equal to a last sequence number also comprises a TCP downlink retransmission packet when a session ending control message exists to signify that a mobile portion of the mobile data flow has ended.

6. The method of claim 1 wherein using the TCP packets to detect when the mobile data flow has been dropped by a corresponding mobile network comprises:
discarding packets that do not comprise TCP packets.

7. The method of claim 6 wherein using the TCP packets to detect when the mobile data flow has been dropped by a corresponding mobile network comprises:
tracking TCP sequence numbers as correspond to the packet data flow.

8. The method of claim 7 wherein using the TCP packets to detect when the mobile data flow has been dropped by a corresponding mobile network comprises:
when a present downlink TCP packet sequence number is less than or equal to a last sequence number, setting a TCP retransmission ending indicator;
when a present uplink TCP packet is detected, clearing the TCP retransmission ending indicator.

9. The method of claim 8 wherein using the TCP packets to detect when the mobile data flow has been dropped by a corresponding mobile network comprises:
determining whether a mobile network-sourced session ending control message has been sent to indicate that mobile portion of the mobile data flow has ended and, when true, determining whether the TCP retransmission ending indicator is set.

10. The method of claim 9 wherein using the TCP packets to detect when the mobile data flow has been dropped by a corresponding mobile network comprises:
when the current TCP packet comprises a positive TCP retransmission ending indicator under such circumstances, determining that the mobile data session has been dropped.

11. The method of claim 1 further comprising:
identifying a service delivery component that is at least partially responsible for dropping the mobile data session.

12. The method of claim 11 wherein identifying a service delivery component that is at least partially responsible for dropping the mobile data session comprises obtaining identifying information for the service delivery component from a packet data protocol (PDP) activation message on a mobile core network interface.

13. An apparatus comprising:
a network interface configured and arranged to receive Transfer Control Protocol (TCP) packets as comprise a part of a packet data flow that comprises, at least in part, a mobile data flow;
a processor operably coupled to the network interface and configured and arranged to use the TCP packets to detect when the mobile data flow as comprises a mobile data session has been dropped by a corresponding mobile network.

14. The apparatus of claim 13 wherein the TCP packets comprise mirrored mobile data packets.

15. The apparatus of claim 13 wherein the processor is further configured and arranged to use the TCP packets to detect when the mobile data flow has been dropped by a corresponding mobile network by:
tracking TCP sequence numbers as correspond to the packet data flow; and
detecting TCP downlink retransmission packets.

16. The apparatus of claim 13 wherein the processor is further configured and arranged to use the TCP packets to detect when the mobile data flow has been dropped by a corresponding mobile network by decoding the data flow up to an Internet Protocol layer.

17. The apparatus of claim 13 wherein the processor is further configured and arranged to use the TCP packets to detect when the mobile data flow has been dropped by a corresponding mobile network by determining whether a present TCP packet which has a sequence number that is less than or equal to a last sequence number also comprises a TCP downlink retransmission packet when a session ending control message exists to signify that a mobile portion of the mobile data flow has ended.

18. The apparatus of claim 13 wherein the processor is further configured and arranged to use the TCP packets to detect when the mobile data flow has been dropped by a corresponding mobile network by:
discarding packets that do not comprise TCP packets.

19. The apparatus of claim 18 wherein the processor is further configured and arranged to use the TCP packets to detect when the mobile data flow has been dropped by a corresponding mobile network by:
tracking TCP sequence numbers as correspond to the packet data flow.

20. The apparatus of claim 19 wherein the processor is further configured and arranged to use the TCP packets to detect when the mobile data flow has been dropped by a corresponding mobile network by:
when a present downlink TCP packet sequence number is less than or equal to a last sequence number, setting a TCP retransmission ending indicator;
when a present uplink TCP packet is detected, clearing the TCP retransmission ending indicator.

21. The apparatus of claim 20 wherein the processor is further configured and arranged to use the TCP packets to detect when the mobile data flow has been dropped by a corresponding mobile network by:
determining whether a mobile network-sourced session ending control message has been sent to indicate that mobile portion of the mobile data flow has ended and, when true, determining whether the TCP retransmission ending indicator is set.

22. The apparatus of claim 21 wherein the processor is further configured and arranged to use the TCP packets to detect when the mobile data flow has been dropped by a corresponding mobile network by:
when the current TCP packet comprises a positive TCP retransmission ending indicator under such circumstances, determining that the mobile data session has been dropped.

23. The apparatus of claim 13 wherein the processor is further configured and arranged to identify a service delivery component that is at least partially responsible for dropping the mobile data session.

24. The apparatus of claim 23 wherein the processor is further configured and arranged to identify a service delivery component that is at least partially responsible for dropping the mobile data session by obtaining identifying information for the service delivery component from a packet data protocol (PDP) activation message on a mobile core network interface.
